(19) United States
(12) Patent Application Publication
(10) Pub. No.: US 2018/0283089 A1
(43) Pub. Date: Oct. 4, 2018

(54) SEALED WEATHERSTRIP CORNER PADS

(71) Applicant: Amesbury Group, Inc., Amesbury, MA (US)

(72) Inventors: Peter Mertinooke, Amesbury, MA (US); John Huntress, Amesbury, MA (US)

(73) Assignee: Amesbury Group, Inc., Amesbury, MA (US)

(21) Appl. No.: 15/945,560

(22) Filed: Apr. 4, 2018

Related U.S. Application Data
(60) Provisional application No. 62/481,413, filed on Apr. 4, 2017.

(51) Int. Cl. E06B 7/23; B29C 65/08; B29C 65/74; B29C 65/00; B29C 65/48

(52) U.S. Cl. CPC E06B 7/2303; B29C 65/08; B29C 65/74; B29K 2023/12; B29C 66/712; B29C 65/48; B29C 66/727

(57) ABSTRACT

A method of manufacturing a corner pad weatherseal includes forming a substantially E-shaped foam profile. The foam profile has several legs and a portion of the foam profile is coated in resin. A backer is secured to the foam profile in such a way that a lumen is formed between the foam and the backer.

### CROSS-REFERENCE TO RELATED APPLICATION

This application claims priority to and the benefit of U.S. Provisional Patent Application Ser. No. 62/481,413, filed Apr. 4, 2017, entitled “Sealed Weatherstrip Corner Pads,” the disclosure of which is hereby incorporated by reference herein in its entirety.

### INTRODUCTION

Hinged swing entry doors that are designed for use in residential housing applications typically have an interface between the door and door frame that consists of a gap. The gaps are frequently filled with weatherseals (also called weatherstripping, weather strips, seals, etc.) of various designs that are often mounted to base structures that are pressed into “kerf slots” in the frame. The weatherseals are designed to maintain an effective barrier against unwanted external environmental conditions, especially the infiltration of air and water. The weatherseals helps to separate the internal and external environments by preventing the passage of noise, dust, heat, and light from one side of the door unit to the other through the gap. Certain weatherseals also have application in sliding or hinged windows and sliding doors. For clarity, however, the technologies described herein will be made in the context of hinged doors.

Most residential houses have at least one swing entry door unit that has a frame, hinges, and a latching mechanism that holds the door in place against a seal in order to isolate the indoor environment from the outdoor environment by reducing air and water infiltration. The hinge, latch, and head represent one general sealing challenge to weatherseals designers while the sill poses another unique challenge. At the still, when air pressure and water are applied to the exterior of the door unit, air and water may penetrate the door opening at the lower corners where the perimeter weatherseal meets the sill cap. As such, corner pads may be mounted to the door fame above the sill cap and help prevent air and water infiltration in the lower corners. Some known corner pads are urethane foam pads, however, since urethane foam has a relatively open cell structure the water and air also penetrates the door opening. Additionally, a modified urethane, known as “low wick” urethane may be used to repel ingress of water, however, the modified urethane does not reduce ingress of water under pressure from wind and rain.

Urethane foam weatherseals currently marketed under trade names such as Q-Lon (available from Schlegel of Rochester, N.Y.) and LoxSeal (available from Loxcreen Company of West Columbia, S.C.) are variations of open cell urethane foam molded in polyethylene film. Q-Lon in particular displays excellent recovery, low operating force, and low cost while being considered a low wick type urethane. In addition, the open cell structure allows the air to quickly evacuate from the foam when the weatherseal is compressed, reducing operating forces to minimal operating performance while maintaining adequate sealing performance. EPDM (ethylene propylene diene monomer (M-class)) rubber foam door seal profiles with a dense EPDM base mounting stem are also available, e.g., from Lauren Manufacturing Company of New Philadelphia, Ohio.

### SUMMARY

In one aspect, the technology relates to a method of manufacturing a corner pad weatherseal including: forming a foam profile, wherein the foam profile has a substantially E-shaped profile having a plurality of legs and a resin coating at least a portion of the foam profile; and securing a backer to the foam profile such that at least one lumen is formed between the foam and the backer. In an example, the method includes sealing at least one end of the weatherseal so as to form an at least partially-sealed corner pad. In another example, securing the backer includes adhering at least one leg of the profile to the backer such that two lumens are formed. In yet another example sealing at least one end of the weatherseal includes fusing the at least one end with a heated element such that the at least one lumen is closed at the at least one end. In still another example, sealing at least one end of the weatherseal includes compressing the at least one end against a heated surface such that the at least one lumen is closed at the at least one end.

In another example of the above aspect, sealing at least one end of the weatherseal includes ultrasonically fusing the at least one end such that the at least one lumen is closed at the at least one end. In an example, sealing at least one end of the weatherseal includes: cutting the weatherseal into a predetermined length; folding the cut weatherseal; at least one of applying a heated element to the fold, compressing the fold against a heated surface, and ultrasonically fusing the fold such that such that the at least one lumen is closed at the at least one end; and cutting the weatherseal at the seal such that two at least partially-sealed corner pads are formed. In another example, sealing at least one end of the weatherseal further includes sealing both ends of the weatherseal. In yet another example the foam profile is a thermoplastic elastomer foam, and wherein the backer is a polypropylene.

In another aspect, the technology relates to a corner pad weatherseal having: a foam profile having a substantially E-shaped profile; a resin coating at least a portion of the profile; and a backer adhered to the foam profile such that at least one lumen is formed between the foam and the backer. In an example, the foam and the backer are sealed at one end such that the at least one lumen is closed at the end. In another example, the foam and the backer are sealed at both ends such that the at least one lumen is closed at both ends. In yet another example the E-shaped profile has two legs secured to the backer, wherein the at least one lumen is disposed along the backer between adjacent legs. In still another example, the two legs have two outer legs and an inner leg, and wherein the at least one lumen includes two lumens, and wherein one lumen is disposed on either side of the inner leg.

In another example of the above aspect, the E-shaped profile includes an inner leg height at the inner leg, and wherein the two lumens each include a lumen height, and wherein the lumen height is greater than the inner leg height. In an example, the at least one lumen includes a lumen width greater than a width of either of the two legs. In another example, the at least one lumen includes a lumen height, wherein the lumen height is less than the lumen width. In yet another example, the corner pad weatherseal further includes an axial plane, wherein the E-shaped profile is substantially symmetrical about the axial plane. In still another example, the resin coats at least an elongate edge of the foam profile and at least a portion of the backer adjacent the elongate edge. In another example, the foam profile includes thermoplastic elastomer and wherein the backer includes polypropylene.

### BRIEF DESCRIPTION OF THE DRAWINGS

FIG. 1 is an example corner pad mounted to a door frame.

FIG. 2A is a perspective view of a weatherseal that may be used for the corner pad shown in FIG. 1.

FIG. 2B is a cross-sectional view of the weatherseal shown in FIG. 2A.

FIG. 3 is a cross-sectional view of another weatherseal that may be used for the corner pad shown in FIG. 1.

FIG. 4 depicts a method of forming the corner pad.

FIG. 5 is a perspective end view of the corner pad shown in FIG. 1.

FIG. 6 is a perspective view of the weatherseal shown in FIG. 2A having an ultrasonic fuse.

FIG. 7 is a perspective view of another example corner pad.

### DETAILED DESCRIPTION

It is desirable that weatherseals, such as corner pads, have good performance in the following areas and be properly certified by AAMA, NWWDA, NFRC, and other voluntary accreditation bodies:

(A) Recovery/Resistance to Compression Set: The weatherseal should recover to a condition near its original uncompressed state after being compressed for a period of time.

(B) Weatherable/UV Resistant: The weatherseal should maintain dimensional and performance attributes after exposure to weather and UV light conditions.

(C) Water Absorption/Wicking: In cold climates, water absorption into the cell structure can cause problems when the water freezes and expands. The seal should allow air to pass freely through the seal matrix (not across the sealing surface), but should not allow water to penetrate the seal matrix for the risk of freezing.

(D) Compression Force: A weatherseal should provide the proper range of operating force, or CLD (Compression Load Deflection) while tolerating a range of forces from “slamming” of a door to the low operating force of a child or elderly person (so as to meet, e.g., ADA compliance). Too low a CLD will fail to prevent air and water penetration, while too high a CLD might prevent proper closing.

Various materials may be used to manufacture corner pads, for example, but not limited to, open cell urethane foam molded in polyethylene film, ethylene propylene diene monomer (M-class) (EPDM), as well as thermoplastic elastomer (TPE) and thermoplastic vulcanisate (TPV).

TPE/TPV weatherseal designs frequently include a solid foam core of thermoplastic elastomer foam surrounded by a generally impervious outer resin coating or skin material in order to provide protection from UV degradation and from physical damage. Such weatherseals are described for example in U.S. Pat. Nos. 5,607,629; 5,393,796; and 5,192,586, the disclosures of which are hereby incorporated by reference in their entireties. Recent designs utilize a variety of surface options including covering with polyethylene film, providing bare foam areas (e.g., without a resin coating or skin material), applying low friction coatings, leaving large surface areas with no coating to reduce force and increase flexibility, and incorporating silicone and other additives to provide surface lubrication and protection. Certain of these designs are described in the patents identified above, as well as U.S. Pat. No. 7,718,251 and U.S. Patent Application Publication No. 2016/0237738 the disclosures of which are hereby incorporated by reference in its entirety. The technology described herein can benefit from all of the aforementioned surface treatments in addition to yet-to-be developed methods and materials in order to further enhance the product's performance characteristics. Such TPE foam weatherseals are available under the brand name Foam-Tite® by Amesbury Group, Inc., of Amesbury, Mass.

Existing TPE foam is generally considered a substantially closed-cell foam cell structure due to its resistance to water penetration. Microscopic examination reveals that many of the cells actually have cell walls that open to adjacent cells to various degrees. During cell formation, these small openings allow the blowing agent, gaseous water (steam), to escape the cell structure and upon cooling, be replaced with air until equilibrium is reached between the internal and external pressures. Due to the substantially closed-cell foam cell structure, TPE foam weatherseals provide excellent resistance to water infiltration, which makes them very desirable for use in exterior door weatherseals such as corner pads.

However, due to the closed-cell foam cell structure, TPE foam corner pads offer higher than desirable CLD, which ultimately restricts their use in lower door corners. As solid TPE foam is compressed, air that is contained within the cells is forced through a network of microscopic interconnections between the cells in order for the foam to take on its compressed shape. These interconnections have been seen to occupy from less than about 10% to greater than about 30% of the cell wall surface, depending on such foam-forming factors as polymer melt viscosity, melt temperature, melt strength, nucleating additives, and other material and operating factors and conditions. In the case whereby the foam has been coated on the surface, the only evacuation route for the ambient air that fills the cells is via the ends of the profile. In swing door applications, however, there is generally inadequate time to allow the air to properly evacuate the cell structure through the ends of the weatherseals as the door is closed, especially when it is “slammed” shut, because of the thickness of the weatherseal. This phenomenon generates a higher than acceptable operating force. In a truly closed cell structure wherein the gas that fills each cell remains completely captive, compression of the foam does not evacuate the gas and the compression rises significantly as a function of the internal gas pressure.

In order for TPE foam weatherseals to be used for corner pads, the CLD of the weatherseal should be low enough that the door may be properly closed, without having to apply additional force thereto. If the CLD is too high, the door may not close properly, which can be particularly difficult for users with disabilities. However, the weatherseal should collapse with little applied force, since the weatherseal needs to retain sufficient resiliency across its length so as to bridge any gaps between the door and the frame. Additionally, to the extent water is drawn into the weatherstrip, free-flowing drainage of the water is desirable.

Recent developments in thermoplastic elastomer foaming technology have allowed the design and development of new profile shapes, configurations, and features that allow TPE foam to match or exceed the performance of urethane foam weatherseals. For example, the technologies as described herein include, e.g., weatherseals that incorporate one or more hollow channels or lumens in order to provide easier closing force. Other unique performance features and characteristics are also described herein.

Although the corner seal weatherstrips described herein are described previously in the context of TPE, other materials such as any of those described above are contemplated.

In a door seal, one or more continuous hollow tubular voids or lumens may extend the full length of the weatherstrip, such that the atmospheric air contained within the cell structure in its relaxed state can be voided from the weatherseals very rapidly upon compression. This allows the door to close with minimal force through the last inch or so of its closing distance. However, in corner pads, air and water may migrate up through the lumens, allowing excessive air and water infiltration into the doorway. In an example, water that has migrated into the lumen may be expelled from an open end of the lumen when the door closes.

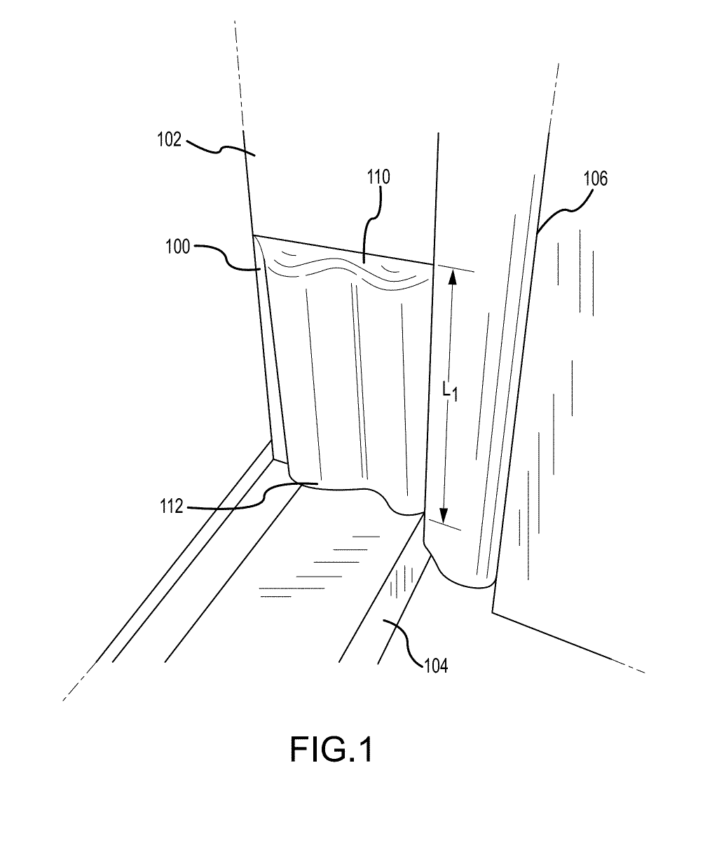

FIG. 1 is an example corner pad 100 mounted to a door frame 102. The corner pad 100 is mounted above a sill cap 104 and adjacent to a perimeter weatherstrip 106. The corner pad 100 has a length L₁ that extends above the sill cap 104 and may be secured to the door frame 102 with an adhesive, such as glue or any other type of adhesive type fastener. Nails or other mechanical fasteners may also be used. Generally, the corner pad 100 is manufactured with a TPE foam cell structure as discussed further below, and as such is highly resistant to water penetration. However, if water and/or air does migrate through the corner pad 100, at a top end 110 of the corner pad 100, the corner pad 100 is sealed such that air and water are restricted from channeling through the pad 100 when the door is closed. At a bottom end 112 of the corner pad 100, the corner pad 100 may be open such that any water may drain out the bottom.

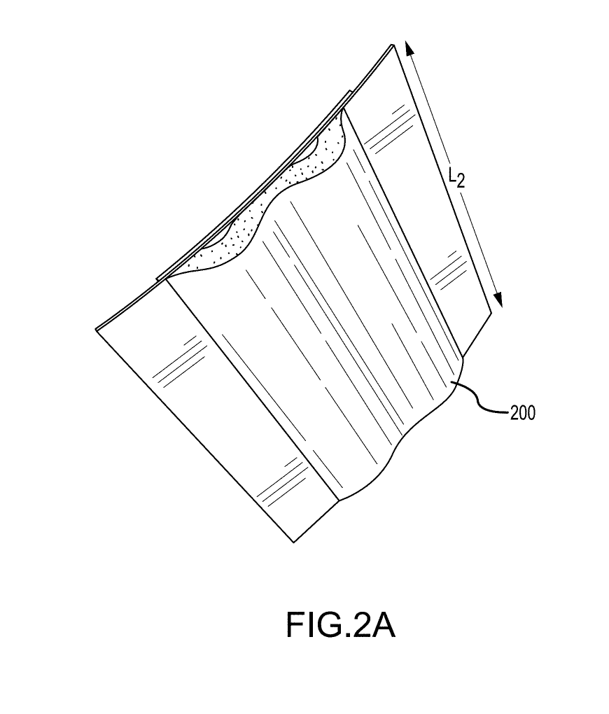

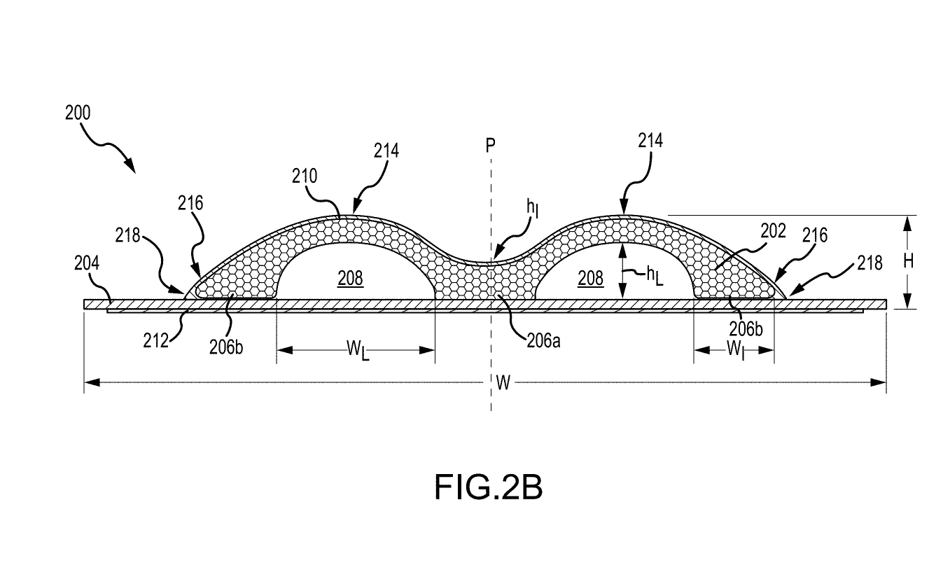

FIG. 2A is a perspective view of a weatherseal 200 that may be used for the corner pad 100 (shown in FIG. 1). FIG. 2B is a cross-sectional view of the weatherseal 200. Referring concurrently to FIGS. 2A and 2B, the weatherseal 200 includes an extruded foam profile 202 secured to a backer 204. The profile 202 is substantially M- or E-shaped with three legs 206 that extend to the backer 204. The backer 204 is a polypropylene layer that is secured to each free end of the profile legs 206 such that two lumens 208 are formed. An inner leg 206a is disposed between and adjacent to the two outer legs 206b. In the example, the profile 202 is secured to the backer 204 with hot glue, although any other suitable adhesive may be used. Additionally, a resin coating 210 is formed over the exterior surface of the profile 202. An adhesive 212, such as a peel and stick adhesive layer, may be applied to the backer 204 such that the corner pad 100 is securable to a door frame.

In the example, the weatherseal 200 has a length L₂ about 4 inches, though other lengths are contemplated. Additionally, the weatherseal 200 has a width W of about 2 inches and a height H of about 0.23 inches. In alternative example, the weatherseal 200 may have any other size and/or shape to enable the corner pad 100 to function as described herein. The weatherseal 200 may be formed by co-extruding the foam profile 202 along with the resin 210 so as to coat at least a portion of the profile 202. The foam profile 202 may then be secured to the backer 204 (which may be extruded substantially simultaneously with the foam profile 202 and the resin 210) such that the lumens 208 are defined between the profile 202 and the backer 204. In another example, either or both of the foam profile 202 and resin 210 and the backer 204 may be extruded, stored (via rolling or other system/mechanism), then unrolled and assembled into the finished weatherseal 200. The foam profile 200 and resin 210 and the backer 204 may be extruded in a continuous process, and then glued together as described herein. The resulting weatherseal 200 may then be cut into desired lengths for further processing as disclosed herein. In yet another example, after extrusion, the foam profile 202 and resin 210 and the backer 204 may be cut separately into desired lengths and then sealed together individually. The lumens 208 enable the weatherseal 200 to have a lower CLD in order to provide an easier closing force.

A number of dimensional relationships may also be advantageous for proper performance of the weatherseal 200 when used as a corner pad 100. For example, the inner leg 206a may have an inner leg height h_{I} (measured from a top surface of the backer 204) that may be less than the lumen height h_{L} (also measured from the top surface). This helps the weatherseal 200 attain the proper shape for sealing purposes without causing excessive friction against a door as it slides against the resin coating 210. For example, the reach of the weatherseal 200 is defined by the height H thereof. By having the lower inner leg height h_{I}, excess friction is reduced. Additionally, the lumen includes a lumen width w_{L}, which may be greater than a leg width w_{I}. It is further noted that the lumen height h_{L} is also less than the lumen width w_{L}. This helps prevent the lumen 208 from collapsing to the side when acted upon by a door closing thereagainst. Such a collapse may prevent air from evacuating efficiently from the lumen 208, which can increase CLD. Instead, the foam profile 202 compresses in a controlled movement towards the backer 204.

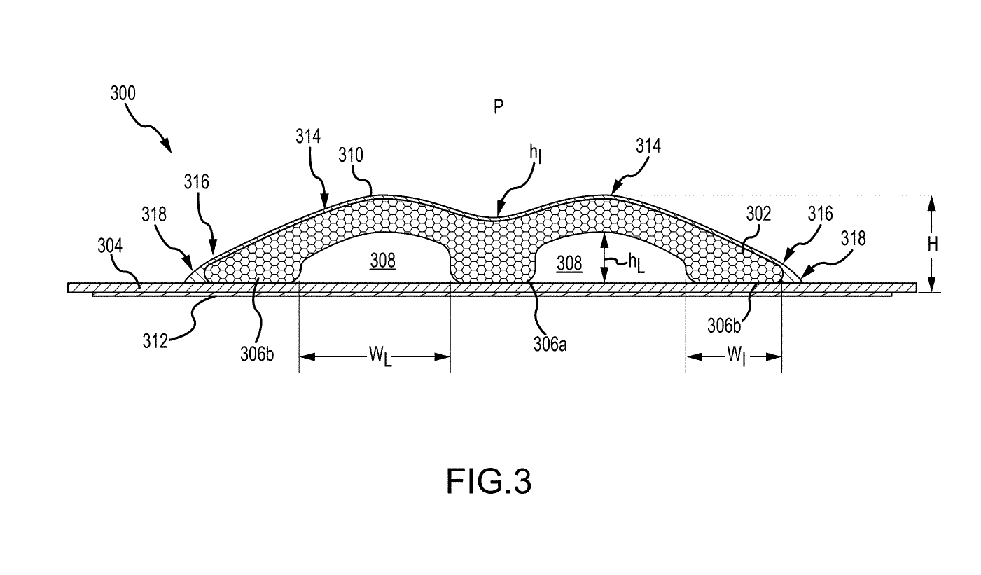

FIG. 3 is a cross-sectional view of another weatherseal 300 that may be used for the corner pad 100 (shown in FIG. 1). Similar to the weatherseal 200 described above, the weatherseal 300 includes an extruded foam profile 302 having legs 306 secured to a backer 304 such that a plurality of lumens 308 are formed. Additionally, a resin coating 310 is formed over the exterior surface of the profile 302 and an adhesive layer 312 is secured to the backer 304. In this example, the profile 302 is formed from additional cells such that the lumens 308 are smaller giving the weatherseal 300 an increased CLD when compared to the weatherseal of FIG. 2B.

As with the example of FIG. 2A, a number of dimensional relationships may also be advantageous for proper performance of the weatherseal 300. The inner leg 306a may have an inner leg height h_{I} (measured from a top surface of the backer 304) that may be less than the height H of the weatherseal 300. This helps the weatherseal 300 attain the proper shape for sealing purposes without causes excessive friction against a door as it slides against the resin coating 310. Additionally, the lumen 308 includes a lumen width w_{L}, which may be greater than the leg width w_{I}. It is further noted that the lumen height h_{L} is also less than the lumen width w_{L}. This helps prevent the lumen 308 from collapsing when acted upon by a door closing thereagainst. Such a collapse may prevent air from evacuating efficiently from the lumen 308, which can increase CLD. Instead the weatherseal 300 will compress towards the backer 304.

In the examples depicted in both FIGS. 2B and 3, the weatherseals 200, 300 include an elongate axial plane P. The weatherseals 200, 300 may be substantially symmetrical on each side thereof, thus allowing for installation with either sloped edge 214, 314 facing the direction of closing of a door. Both examples 200, 300, as well as other examples manufactured consistent with the disclosures herein, are also formed so as to prevent separation of the profile 202, 302 from the backer 204, 304. Each profile 202, 302 includes elongate edge portions 216, 316 on either side of the profile 202, 302, at the outer legs 206b, 306b. The resin coating 210, 310 at these edge portions 216, 316 includes a resin ramp 218, 318 which helps secure the resin coating 210, 310 to the backer 204, 304. Additionally, the resin ramps 218, 318 are sloped so as to provide a smooth leading contact surface that protects the profiles 202, 302 from excessive forces thereagainst, which may cause the profiles 202, 302 to separate from the backer 204, 304.

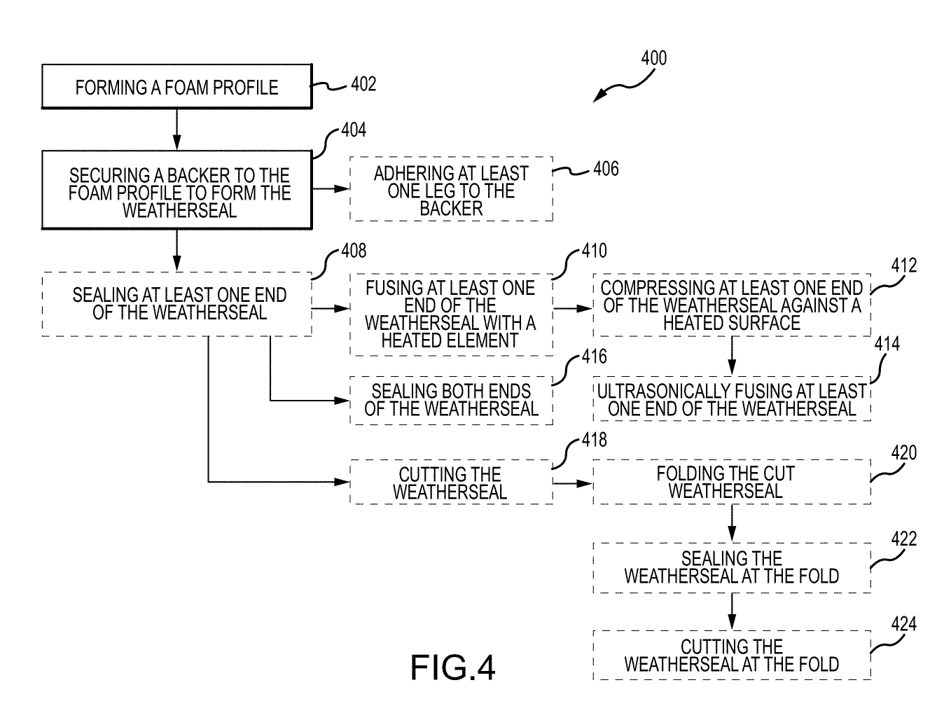

FIG. 4 depicts a method 400 of forming a corner pad. The method 400 begins with forming a foam profile, operation 402, wherein the foam profile has a substantially M- or E-shaped profile having a plurality of legs and a resin coating at least a portion of the foam profile. In operation 404, the corner pad is formed by securing a backer to the foam profile such that at least one lumen is formed between the foam profile and the backer. In operational operation 406, securing the backer may include adhering at least one leg of the profile to the backer such that two lumens are formed. If a partially-sealed corner pad is desired, operation 408 may be performed, which includes sealing at least one end of the weatherseal. This sealing may be performed in a number of ways. In an example, optional operation 410 contemplates fusing the at least one end with a heated element such that the at least one lumen is closed at the at least one end. In another example, operation 412 includes compressing the at least one end against a heated surface such that the at least one lumen is closed at the at least one end. In another example, operation 414 includes ultrasonically fusing the at least one end such that the at least one lumen is closed at the at least one end.

If a fully-sealed corner pad is desired, operation 416, sealing both ends may be performed. In another example, sealing may include a more complex process. For example, in operation 418, the weatherseal may be cut to a predetermined length. Thereafter, in operation 420, the cut weatherseal is folded. In operation 422, the folded weatherseal may be sealed at the fold. Such sealing may include the above described sealing operations, e.g., applying a heated element to the fold, compressing the fold against a heated surface, or ultrasonically fusing the fold such that such that the at least one lumen is closed. Thereafter, the corner pad weatherseal may be cut at the seal such that two at least partially-sealed corner pads are formed, operation 424. As described elsewhere herein, the foam profile may be a thermoplastic elastomer foam and the backer may be a polypropylene. Other materials are described herein.

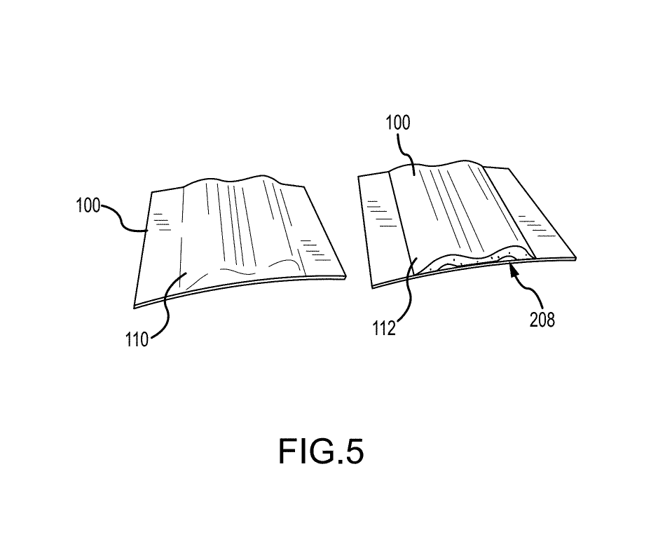

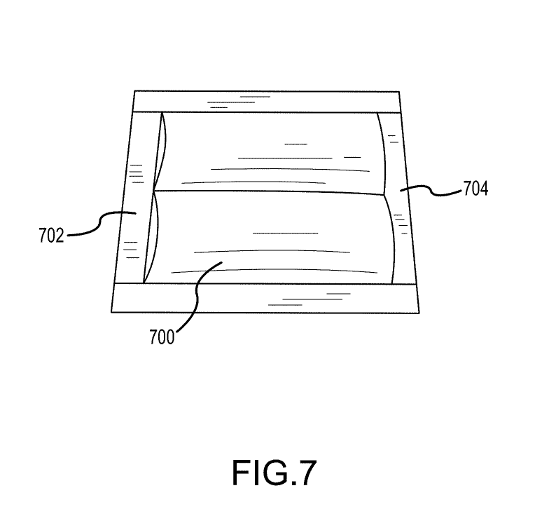

FIG. 5 is a perspective view of multiple partially-sealed corner pads 100 (shown in FIG. 1). As illustrated in FIG. 5, the top end 110 of each corner pad 100 is heat sealed to reduce air and water penetration. However, a bottom end 112 remains unsealed to reduce the corner pad's CLD values as discussed above. As such, the lumens 208 remain open at the bottom end 112. In alternative examples, for example, FIG. 7 described below, the corner pad 100 may be sealed at both the top and bottom ends to further reduce water and air migration through the corner pad. However, by sealing both ends the CDL may slightly increase due to the encapsulation of air, but not enough to significantly impact door operation.

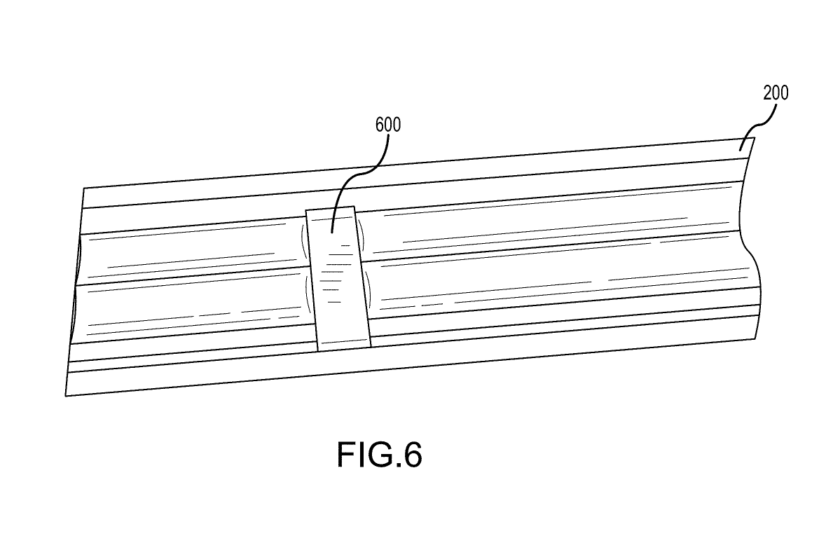

FIG. 6 is a perspective view of the weatherseal 200 having an ultrasonic fuse or weld 600. The weatherseal 200 may be alternatively sealed by an ultrasonic welder. In this example, a non-heated blade or straight edge compresses the weatherseal 200 against the surface of an ultrasonic or vibration-generating device, to reduce the foam 202, the backer 204, and the resin 210 into a solid layer and close the lumens 208 at the fuse 600. As such, the weatherseal 200 may be then cut along the fuse 600 to form each corner pad 100 with a sealed top end 110. In alternative embodiments, any other method known to one skilled in the art of melting the end of the weatherseal 200 to reduce the foam 202, the backer 204, and the resin 210 into a solid layer and close the lumens 208 may be used to enable formation of the corner pad 100.

FIG. 7 is a perspective view of another example corner pad 700. In this example, both ends 702, 704 of the corner pad 700 are sealed using any of the methods described above to form two completely closed lumens therein.

The weatherseals described herein may be manufactured in accordance with processes now known or developed in the future. Profiles may be cut from extruded, cooled pieces of foam material utilizing laser cutting processes, hot wire cutting processes, or other processes. The weatherseals may be cut from a rotary blade, for example, the weatherseal may be machined with a high speed cutter to form the lumen, and then mounted to the backer. Flexible adhesive systems can be used to assemble segments in a piecewise configuration by passing two elongated machined strips of foam over an adhesive lick roll and joining the strips together, thus forming the foam profiles. Other methods of manufacture include laminating multiple elongates subcomponent foam rod-shaped extrusions into a shape with a set of guides and rollers using a combination of heat and coating materials. Small foam beads or assembled tubes with cellular walls may be fused together in a continuous shape. The weatherstrip or portions thereof may be 3D printed with a modified Stratasys or similar printer. Lumens formed within the profiles may be cut by similar technologies, or may be machined or otherwise formed in the profiles utilizing, e.g., elongate drilling bits or other machining tools.

Desirable manufacturing processes also include extrusion and co-extrusion processes, such as those described in U.S. Pat. Nos. 5,607,629; 5,393,796; and 5,192,586, the disclosures of which are hereby incorporated by reference herein in their entireties. U.S. Pat. No. 7,718,251 and U.S. Patent Application Publication No. 2016/0237738 also describe fabric-clad foam weatherseals, and such technologies may also be incorporated into the profile technologies described herein. Electrical discharge machining (EDM) and CNC machining methods and design innovations have led to production of extrusion dies and back plates that may be used to produce complex profiles having one or more lumens, varied skin thicknesses, and other features. Very thin die openings with very delicate mandrel spider leg supports allow for unique foam shape control for very thin outer and inner reinforcing walls. Thin die openings also allow the foam to “knit” back together, creating a seamless finished product. The thin dies also allow a shape to maintain an inflated structure with an inner network of inner reinforcing walls or ribs, thus providing a process to design and produce, e.g., very large, complex multi-hollow foam profiles. Back-plates can be used that approximate the shape of the profile and guide the melt in a predetermined manner toward specific areas of the front plate.

The dies may be used to produce profiles having walls only three cells thick in certain locations. TPE foam cells vary from 0.010″-0.050″ diameter, depending on the polymer composition and the operating parameters. The cells are somewhat interactive with adjacent cells via random openings in their walls, allowing a restricted flow of air through the cell matrix. This allows air to be evacuated upon foam compression and to be returned to the cell matrix upon de-compression. The dies provide good shape control since the cells expand laterally, with minimal distortion, and allow for precise flexibility in areas designed to be hinges. Thin internal walls may need smaller cell structure with lower porosity in order to limit internal off-gassing while achieving low densities. Internal off-gassing inflates and distends lumens and can be controlled during the cooling process. Further development and control of foam cell size and density through process controls, base material changes, and additives may control rate of off-gassing during cell formation.

Materials utilized in the manufacture of the described weatherseals are identified in U.S. Pat. Nos. 5,607,629; 5,393,796; and 5,192,586, the disclosures of which are hereby incorporated by reference herein in their entireties. Materials also include SANTOPRENE™, manufactured by the ExxonMobil Corporation; SARLINK™ manufactured by Teknor Apex Company; and Elastron Thermoplastic Elastomers, manufactured by Elastron Kimya A.S. Thermoset components may be applied during manufacture to improve compression set resistance.

Dimensions depicted in the figures are for example only. Weatherseals and/or corner pads formed therefrom may be manufactured with virtually any other dimensions as required or desired for a particular application.

While there have been described herein what are to be considered exemplary and preferred embodiments of the present technology, other modifications of the technology will become apparent to those skilled in the art from the teachings herein. The particular methods of manufacture and geometries disclosed herein are exemplary in nature and are not to be considered limiting. It is therefore desired to be secured in the appended claims all such modifications as fall within the spirit and scope of the technology. Accordingly, what is desired to be secured by Letters Patent is the technology as defined and differentiated in the following claims, and all equivalents.

What is claimed is:

1. A method of manufacturing a corner pad weatherseal comprising:
forming a foam profile, wherein the foam profile has a substantially E-shaped profile having a plurality of legs and a resin coating at least a portion of the foam profile; and
securing a backer to the foam profile such that at least one lumen is formed between the foam and the backer.

2. The method of claim 1, further comprising sealing at least one end of the weatherseal so as to form an at least partially-sealed corner pad.

3. The method of claim 1, wherein securing the backer comprises adhering at least one leg of the profile to the backer such that two lumens are formed.

4. The method of claim 2, wherein sealing at least one end of the weatherseal comprises fusing the at least one end with a heated element such that the at least one lumen is closed at the at least one end.

5. The method of claim 2, wherein sealing at least one end of the weatherseal comprises compressing the at least one end against a heated surface such that the at least one lumen is closed at the at least one end.

6. The method of claim 2, wherein sealing at least one end of the weatherseal comprises ultrasonically fusing the at least one end such that the at least one lumen is closed at the at least one end.

7. The method of claim 21, wherein sealing at least one end of the weatherseal comprises:
cutting the weatherseal into a predetermined length;
folding the cut weatherseal;
at least one of applying a heated element to the fold, compressing the fold against a heated surface, and ultrasonically fusing the fold such that such that the at least one lumen is closed at the at least one end; and
cutting the weatherseal at the seal such that two at least partially-sealed corner pads are formed.

8. The method of claim 2, wherein sealing at least one end of the weatherseal further comprises sealing both ends of the weatherseal.

9. The method of claim 1, wherein the foam profile is a thermoplastic elastomer foam, and wherein the backer is a polypropylene.

10. A corner pad weatherseal comprising:
a foam profile having a substantially E-shaped profile;
a resin coating at least a portion of the profile; and
a backer adhered to the foam profile such that at least one lumen is formed between the foam and the backer.

11. The corner pad weatherseal of claim 10, wherein the foam and the backer are sealed at one end such that the at least one lumen is closed at the end.

12. The corner pad weatherseal of claim 11, wherein the foam and the backer are sealed at both ends such that the at least one lumen is closed at both ends.

13. The corner pad weatherseal of claim 10, wherein the E-shaped profile comprises two legs secured to the backer, wherein the at least one lumen is disposed along the backer between adjacent legs.

14. The corner pad weatherseal of claim 13, wherein the two legs comprises two outer legs and an inner leg, and wherein the at least one lumen comprises two lumens, and wherein one lumen is disposed on either side of the inner leg.

15. The corner pad weatherseal of claim 14, wherein E-shaped profile comprises an inner leg height at the inner leg, and wherein the two lumens each comprise a lumen height, and wherein the lumen height is greater than the inner leg height.

16. The corner pad weatherseal of claim 13, wherein the at least one lumen comprises a lumen width greater than a width of either of the two legs.

17. The corner pad weatherseal of claim 16, wherein the at least one lumen comprises a lumen height, wherein the lumen height is less than the lumen width.

18. The corner pad weatherseal of claim 10, further comprising an axial plane, wherein the E-shaped profile is substantially symmetrical about the axial plane.

19. The corner pad weatherseal of claim 10, wherein the resin coats at least an elongate edge of the foam profile and at least a portion of the backer adjacent the elongate edge.

20. The corner pad weatherseal of claim 10, wherein the foam profile comprises thermoplastic elastomer and wherein the backer comprises polypropylene.
